(19) United States
(12) Patent Application Publication
(10) Pub. No.: US 2026/0288524 A1
(43) Pub. Date: Sep. 24, 2026

(54) CONTAINMENT FOR NON-USER PRINCIPAL STEALING IN A CLOUD ENVIRONMENT

(71) Applicant: Oracle International Corporation, Redwood Shores, CA (US)

(72) Inventors: Adam Knopik, Reston, VA (US); Alexander Gregory Baca, Seattle, WA (US); Nicolas Gordon, Arvada, CO (US); Jennifer LeMond, Auburn, WA (US); Peter Martin Hanily, Dublin (IE); Ryan Daniel Schilcher, Seattle, WA (US); Christopher Robert Baker, Nashua, NH (US); Eric Chin, Andover, MA (US)

(73) Assignee: Oracle International Corporation, Redwood Shores, CA (US)

(21) Appl. No.: 19/088,031

(22) Filed: Mar. 24, 2025

(51) Int. Cl. G06F 9/50

(52) U.S. Cl. CPC G06F 9/5027

(57) ABSTRACT

Techniques for undertaking containment actions in response to detection of stealing of non-user principals within a cloud environment are disclosed. Usage of a non-user principal by a first non-user entity is detected within a cloud environment, wherein the non-user principal was originally assigned to a second non-user entity that is different from the first non-user entity. A detection is made as to whether the non-user principal is assigned to a dynamic group of non-user entities within a tenancy. A detection is made as to whether the non-user principal is an instance principal, a resource principal, or a service principal. One or more containment actions are undertaken, based at least in part on one or both of (i) detecting whether the non-user principal is assigned to the dynamic group of non-user entities and (ii) detecting whether the non-user principal is an instance principal, a resource principal, or a service principal.

### BACKGROUND

A cloud provider provides on-demand, scalable computing resources of a cloud environment to its cloud customers. A cloud customer generally desires to run its cloud resources without monitoring, scanning, or other interference by the cloud provider or other cloud customers. Therefore, the cloud provider offers “tenancies” to its cloud customers. A tenancy is an isolated partition within the cloud environment, such that resources in different tenancies are isolated from each other unless explicitly shared. Each tenancy runs a plurality of virtual machine compute instances.

### BRIEF SUMMARY

In various embodiments, a non-transitory computer-readable medium includes instructions that when executed by one or more processors, cause a system including the one or more processors to perform operations including: detecting, within a cloud environment, usage of a non-user principal by a first non-user entity, wherein the non-user principal was originally assigned to a second non-user entity that is different from the first non-user entity; detecting one or more attributes associated with the non-user principal; and undertaking one or more containment actions responsive to detecting the usage of the non-user principal by the first non-user entity, wherein the one or more containment actions are based at least in part on detecting the one or more attributes associated with the non-user principal.

In an example, detecting the one or more attributes associated with the non-user principal comprises one or more of: detecting whether the non-user principal is assigned to a dynamic group of non-user entities within a tenancy; and detecting whether the non-user principal is an instance principal, a resource principal, or a service principal. In an example, undertaking the one or more containment actions include: detecting that the non-user principal is a service principal and is assigned to a dynamic group; and in response to detecting that the non-user principal is a service principal and is assigned to the dynamic group, disabling the dynamic group. In an example, undertaking the one or more containment actions include: detecting that the non-user principal is a service principal; and in response to detecting that the non-user principal is a service principal, checking one or more resources within one or more tenancy, to which the first non-user entity provided a service using the service principal, to detect anomalous issues with the one or more resources caused by the first non-user entity. In an example, undertaking the one or more containment actions include: detecting that (i) the non-user principal is an instance principal or a resource principal and (ii) is assigned to a dynamic group; and in response to detecting that the non-user principal is an instance principal or a resource principal and is assigned to the dynamic group, removing the non-user principal from the dynamic group. In an example, the non-user principal is a first non-user principal, and wherein removing the first non-user principal from the dynamic group comprises: tagging each of the first non-user principal and one or more other non-user principals with a pre-specified tag; and removing each non-user principal, which is tagged with the pre-specified tag, from the dynamic group. In an example, removing the non-user principal from the dynamic group comprises: editing a policy of the dynamic group, to remove the non-user principal from the dynamic group. In an example, the non-user principal is a first non-user principal, and wherein the operations further include: detecting, within a cloud environment, usage of a second non-user principal by a third non-user entity, wherein the second non-user principal was originally assigned to a fourth non-user entity that is different from the third non-user entity; wherein the first non-user principal is a service principal that is assigned to a first dynamic group; wherein the second non-user principal is a resource principal or an instance principal that is assigned to a second dynamic group; wherein one or more containment actions for the first non-user principal include disabling the first dynamic group, in response to detecting that the first non-user principal is a service principal; and wherein one or more containment actions for the second non-user principal include removing the second non-user principal from the second dynamic group, in response to detecting that the second non-user principal is a resource principal or an instance principal. In an example, undertaking the one or more containment actions include: detecting that the non-user principal is not assigned to any dynamic group; and in response to detecting that the non-user principal is not assigned to any dynamic group, disabling the non-user principal.

In an example, detecting the one or more attributes associated with the non-user principal comprises detecting whether the non-user principal is assigned to any whitelisted tenancy; and the one or more containment actions undertaken are based on detecting whether the non-user principal is assigned to any whitelisted tenancy. In an example, the non-user principal is a first non-user principal, and wherein the operations further include: detecting, within a cloud environment, usage of a second non-user principal by a third non-user entity, wherein the second non-user principal was originally assigned to a fourth non-user entity that is different from the third non-user entity; wherein the first non-user principal is assigned to a whitelisted tenancy and to a first dynamic group, and wherein the second non-user principal is assigned to a non-whitelisted tenancy and to a second dynamic group; wherein one or more containment actions for the first non-user principal include disabling the first dynamic group; and wherein one or more containment actions for the second non-user principal include removing the second non-user principal from the second dynamic group.

In an example, wherein the non-user principal is assigned to the second non-user entity by an identity and access management (IAM) service. In an example, the non-user principal is stolen from the second non-user entity and provided to the first non-user entity.

In various embodiments, a method comprises: detecting, within a cloud environment, usage of a non-user principal by a first non-user entity, wherein the non-user principal was originally assigned to a second non-user entity that is different from the first non-user entity; detecting whether the non-user principal is assigned to a dynamic group of non-user entities within a tenancy; detecting whether the non-user principal is an instance principal, a resource principal, or a service principal; and undertaking one or more containment actions, based at least in part on one or both of (i) detecting whether the non-user principal is assigned to the dynamic group of non-user entities and (ii) detecting whether the non-user principal is an instance principal, a resource principal, or a service principal. In an example, undertaking the one or more containment actions comprises: detecting that the non-user principal is a service principal and is assigned to a dynamic group; and in response to detecting that the non-user principal is a service principal and is assigned to the dynamic group, disabling the dynamic group.

In an example, undertaking the one or more containment actions comprises: detecting that the non-user principal is a service principal; and in response to detecting that the non-user principal is a service principal, checking one or more resources within one or more tenancy, to which the first non-user entity provided a service using the service principal, to detect anomalous issues with the one or more resources caused by the first non-user entity. In an example, undertaking the one or more containment actions include: detecting that (i) the non-user principal is an instance principal or a resource principal and (ii) is assigned to a dynamic group; and in response to detecting that the non-user principal is an instance principal or a resource principal and is assigned to the dynamic group, removing the non-user principal from the dynamic group.

In various embodiments, a system comprises: one or more processors; and one or more non-transitory computer-readable media storing instructions, which, when executed by the system, cause the system to perform a set of actions including: detecting, within a cloud environment, usage of a non-user principal by a first non-user entity, wherein the non-user principal was originally assigned to a second non-user entity that is different from the first non-user entity; detecting whether the non-user principal is assigned to a dynamic group of non-user entities within a tenancy; detecting whether the non-user principal is an instance principal, a resource principal, or a service principal; and undertaking one or more containment actions, based at least in part on one or both of (i) detecting whether the non-user principal is assigned to the dynamic group of non-user entities and (ii) detecting whether the non-user principal is an instance principal, a resource principal, or a service principal. In an example, undertaking the one or more containment actions comprises: detecting that the non-user principal is a service principal and is assigned to a dynamic group; and in response to detecting that the non-user principal is a service principal and is assigned to the dynamic group, disabling the dynamic group. In an example, undertaking the one or more containment actions comprises: detecting that (i) the non-user principal is an instance principal or a resource principal and (ii) is assigned to a dynamic group; and in response to detecting that the non-user principal is an instance principal or a resource principal and is assigned to the dynamic group, removing the non-user principal from the dynamic group.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a cloud environment that includes (i) a stolen principal detection service for detection of a stolen non-user principal and (ii) a stolen principal containment service for facilitating containment actions in response to a detection of a stolen non-user principal.

FIG. 2 illustrates an example in which a stolen non-user principal is originally assigned to a dynamic group of non-user entities within a tenancy of a cloud environment.

FIG. 3 illustrates an example in which a stolen non-user principal is originally assigned to a non-user entity of a whitelisted tenancy within a cloud environment.

FIG. 4 illustrates an example in which a stolen non-user principal may be any of an instance principal, a resource principal, or a service principal of a cloud environment.

FIG. 5 illustrates a flowchart depicting a method for containment actions to be undertaken, based on detection of a stolen non-user principal.

FIG. 6 illustrates a table depicting example containment actions, e.g., when one or more stolen non-user principals are instance principals.

FIG. 7 illustrates a table depicting example containment actions, e.g., when one or more stolen non-user principals are resource principals.

FIG. 8 illustrates a table depicting example containment actions, e.g., when one or more stolen non-user principals are service principal.

FIG. 9 illustrates a table depicting example containment actions for stolen non-user principals within a whitelisted tenancy versus stolen non-user principals within a non-whitelisted tenancy.

FIG. 10 illustrates a flow chart depicting another method for containment actions to be undertaken, based on detection of a stolen non-user principal.

FIG. 11 depicts a simplified diagram of a distributed system for implementing certain aspects.

FIG. 12 is a simplified block diagram of one or more components of a system environment by which services provided by one or more components of an embodiment system may be offered as cloud services, in accordance with certain aspects.

FIG. 13 illustrates an example computer system that may be used to implement certain aspects.

### DETAILED DESCRIPTION

Maintaining security of a cloud environment involves controlling access to cloud resources based on permissions specified by respective cloud customers. A cloud customer can grant permissions for accessing cloud resources that it rents, but the cloud customer should not be able to grant permissions for accessing cloud resources rented by other customers. A tenancy is a conceptual bucket that holds cloud resources belonging to a particular cloud customer. An administrator of a tenancy has administrative rights to set access policies for cloud resources in the tenancy; an administrator of a tenancy does not have administrative rights to set access policies for cloud resources in another tenancy. A tenancy of a cloud customer is isolated from another tenancy of another cloud customer. A tenancy of a cloud customer includes a plurality of active cloud resources, such as compute instances that are used to host virtual machines. The cloud provider may also have control on one or more tenancies (e.g., cloud provider tenancies), through which the cloud provider may provide one or more services to the cloud customers. Transmission of data from one tenancy to another, unless there is a specific and legitimate need, is not permitted.

Identity and Access Management (IAM) within a cloud environment provides, among other things, authentication and authorization to control access to cloud resources in a cloud environment. Authentication involves verifying that a requester's claims about itself are true. Successful authentication results in granting an identity, also referred to as a “principal,” to the requester. A principal may be granted initially to the requester, and may be periodically or intermittently refreshed. For example, an instance principle is an identity assigned to a compute instance operating within a tenancy. The instance principle can be configured to be assigned to a dynamic group, and policies can be assigned to the dynamic group, which then dictates various permissions associated with the instance. An identity associated with an instance principal is manifested as a session token granted by the IAM to the compute instance. Authorization involves verifying that a requester with a certain identity, as evidenced by presentation of the session token, has permission to access a cloud resource. Successful authorization results in permitting the requested access to the requested cloud resource.

As described above, an instance principle is an identity assigned to a compute instance operating within a tenancy. For example, when a virtual machine (VM) is created within a tenancy of the cloud provider, the VM is issued the instance principal. A resource principle is similarly an identity assigned to a compute resource (e.g., a non-instance compute resource, such as an autonomous database, a memory, a virtual network component, etc.) within the tenancy of a cloud customer. A service principal is a special type of principal to be used by a service within the cloud environment. For example, a service principal enables a service to call a restricted API and access specified customer tenancies as defined in cross-tenancy policy language. A user principal is an identity assigned to a user of the cloud environment.

For purposes of this disclosure, a “non-user entity” of a cloud environment refers to an instance, a resource, or a service of the cloud environment. For purposes of this disclosure, a “non-user principal” refers to any of (i) an instance principle, (ii) a resource principal, or (iii) a service principal, i.e., a principal assigned to a non-user entity of the cloud environment (such as an instance, a resource, or a service). Thus, a non-user principal is granted to a non-user entity.

A problem occurs when a malicious actor “steals” a principal (such as an instance principal, a resource principal, or a service principal) that was not issued to itself. The principals described herein are non-user principals (e.g., instance principle, resource principal, or service principal), which may be stolen by a threat actor.

The stolen principal belongs to a particular tenancy; however, the malicious actor may use the stolen principal from a tenancy belonging to the malicious actor, or from outside of the cloud environment. One example of a principal being stolen is described in co-pending application Ser. No. 18/895,085 (ATL-007/50OR362US/ORC25139268-US-NPR); other ways of stealing a principal may also be possible. Detection of stolen principals has been described with respect to co-pending patent application No. Ser. No. 18/895,089 (ATL-007/50OR362US2/ORC25139268-US-NPR2).

Described herein are example containment actions undertaken in response to detection of stealing of non-user principals. For example, in response to detection of a stolen non-user principal, if an associated dynamic group of cloud resources (e.g., which includes the cloud resources for which the principal is stolen) is deactivated or deleted, this may interrupt the service offered to the cloud client. Thus, containment actions taken have to be judiciously chosen and balanced, so as to not fully interrupt the cloud services offered by the cloud provider, while not compromising risks associated with the stolen principals.

Containment and corrective actions, in response to detection of a stolen non-user principal, may be based on a variety of factors, such as a type of the non-user entity (such as a compute instance, a resource, or a service) for which a corresponding non-user principal has been stolen, whether the stolen non-user principal belongs to a dynamic group, whether a tenancy to which the stolen non-user principal was originally issued is a white-listed tenancy, and/or the like, in an example, as described below in further detail.

As discussed herein, containment and corrective actions may be based at least in part on whether the stolen non-user principal belongs to a dynamic group. A tenancy may include one or more dynamic groups of cloud resources. For example, two or more non-user entities of a tenancy may be grouped in a dynamic group. In a cloud environment, a dynamic group is a logical division comprising a plurality of cloud resources, such that specific policies and permissions are assigned to the cloud resources within the dynamic group. For example, one or more policies for a dynamic group may be created, which may permit non-user entities within the dynamic group to make API calls against services, where the policy references the group name. Thus, instead of creating and assigning policies for individual members of the dynamic group, a single set of policies are assigned to all members of the dynamic group, which facilitates in streamlining formulation and maintenance of policies for cloud resources within the cloud environment. A group may be “dynamic” in the sense that non-user entities may be added dynamically to the group, or deleted dynamically from the group. In an example, if a non-user entity using a stolen non-user principal is part of a dynamic group, containment actions may include one or more of (i) deleting the stolen non-user principal, (ii) taking the non-user entity off the dynamic group, such that the non-user entity no longer enjoys privileges accorded to the members of the dynamic group, (iii) changing the policies of the dynamic group, such that members of the dynamic group may no longer carry out malicious activities while being part of the dynamic group, and/or (iv) deleting the dynamic group altogether. Note that the options (iii) and (iv) affect all members of the group, such as members of the group that did not use any stolen principal. Also, note that for option (ii), no refresh of the group may be needed, as the group is dynamic in nature.

As also discussed herein, containment and corrective actions may be based at least in part on whether the stolen non-user principal belongs to a whitelisted tenancy. A tenancy may be a whitelisted tenancy or a non-whitelisted tenancy. A “whitelisted tenancy” is a tenancy used, for example, by security, development, and/or testing teams of the provider of the cloud environment (or by clients having trust of the cloud provider), such that requests from service principal within the whitelisted tenancy are usually honored. For example, tenancy restrictions for whitelisted tenancy are relatively less compared to other non-whitelisted tenancy. Thus, a non-user entity within a whitelisted tenancy has greater freedom (e.g., compared to non-user entities within non-whitelisted tenancies) to operate on one or more other tenancies of the cloud environment. Thus, if a non-user principal of a whitelisted tenancy is stolen, the stolen non-user principal has relatively higher chances of causing more damage and causing malicious actions on cloud resources within the cloud environment, e.g., compared to a scenario where a non-user principal of a non-whitelisted tenancy is stolen. Accordingly, as described below in further detail, containment actions may be based on whether the stolen non-user principal is of a whitelisted or a non-whitelisted tenancy.

As also discussed herein, containment and corrective actions may be based at least in part on a type of the stolen non-user principal. A non-user principal may be any of an instance principal, a resource principal, or a service principal. In an example, for reasons described below, a stolen service principal has a probability of causing more damage than a stolen instance principal or a stolen resource principal. Accordingly, in an example, corrective actions undertaken may be based on the type of the stolen non-user principal. Merely as an example and as will be described below in further detail, for a stolen instance principal and/or a stolen resource principal, the corresponding compute instance and/or the corresponding resource may be taken out of a corresponding dynamic group. In contrast, for a stolen service principal, in an example, the entire dynamic group including the service principal may be disabled or removed (e.g., access permissions to services within the dynamic group is rescinded). Such differential containment actions between the instance and resource principals versus the service principals may be because of the following reasons. Service principals comprise an internally used principal type for services that usually have a broad swathe of privileges and may affect a larger number of cloud resources. Therefore an urgency required to resolve a situation where a service principal is required is relatively higher (compared to a scenario involving an instance or a resource principal). Disabling the whole dynamic group including the identified service may cause relatively larger disruptive impact on the cloud environment (e.g., compared to removing a single compute instance or a single resource from the dynamic group). However, due to the possibility of other services within the dynamic group also being affected and/or due to the possibility of the relatively large number of cloud entities being possibly affected by the one or more services, such extreme actions are taken based on identifying stolen service principal(s), while similar drastic actions may not be undertaken based on identifying stolen instance and/or resource principals.

Thus, containment and corrective actions, in response to detection of a stolen non-user principal, may be based on a variety of factors, as described below in further detail.

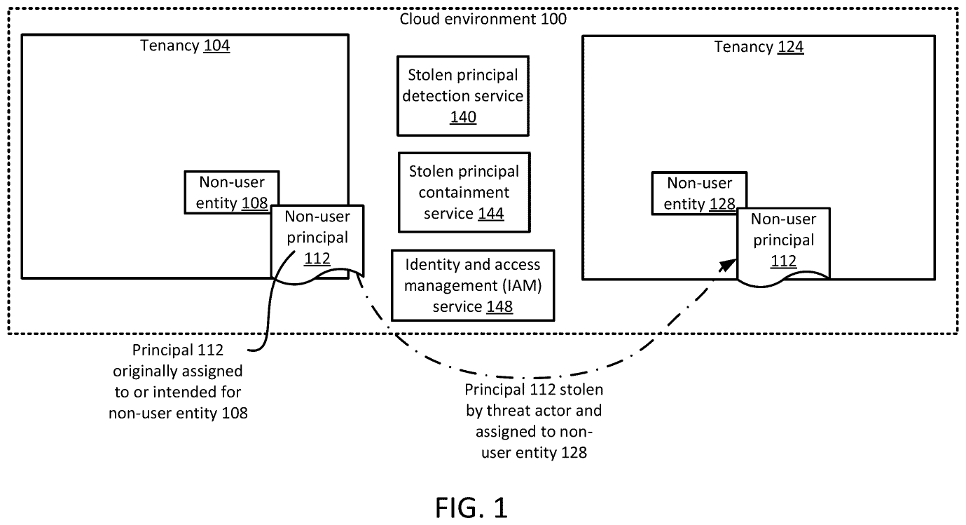

FIG. 1 illustrates a block diagram of a cloud environment 100 that includes (i) a stolen principal detection service 140 for detection of a stolen non-user principal 112 and (ii) a stolen principal containment service 144 for facilitating containment actions in response to a detection of a stolen non-user principal.

The cloud environment 100 comprises a plurality of tenancies, such as tenancies 104 and 124. Although the cloud environment 100 is likely to include more than two tenancies, only two such tenancies 104, 124 are illustrated in FIG. 1.

In an example, a tenancy may be rented to a corresponding cloud customer, and such a tenancy is also referred to as a customer tenancy. A cloud customer can grant permissions for accessing cloud resources within a tenancy that it rents, but the cloud customer should not be able to grant permissions for accessing cloud resources within another tenancy rented by other customers. A tenancy is a conceptual bucket that holds cloud resources belonging to a particular cloud customer. An administrator of a tenancy has administrative rights to set access policies for cloud resources in the tenancy; an administrator of a tenancy does not have administrative rights to set access policies for cloud resources in another tenancy. A tenancy of a cloud customer is isolated from another tenancy of another cloud customer. For example, during a normal course of operation of the tenancies 104, 124, data from a tenancy 104 may not be transmitted to the tenancy 124, and vice-verse. A tenancy of a cloud customer includes a plurality of active cloud resources, such as compute instances that are used to host virtual machines.

The cloud environment 100 may also be used by the provider of the cloud environment, e.g., to provide one or more services to one or more cloud customers of the cloud environment 100. A tenancy used by the provider of the cloud environment, to provide one or more services to one or more customer tenancies, is referred to as service tenancy. Each of the tenancies 104, 124 illustrates in FIG. 1 may be a customer tenancy or a service tenancy.

Each tenancy 104, 124 includes a plurality of non-user cloud entities, such as compute instances, cloud resources, memories, networking components, databases, etc. An example non-user entity 108 is illustrated to be included within the tenancy 104, and an example non-user entity 128 is illustrated to be included within the tenancy 124. Note that each of the tenancies 104, 124 include other non-user entities as well, although only one such non-user entity for each tenancy is illustrated in FIG. 1.

In an example, the cloud environment 100 includes an Identity and Access Management (IAM) service 148 that provides, among other things, authentication and authorization to control access to cloud resources in a cloud environment. An entity desiring access to a cloud resource may be referred to herein as an “access requester” or “requester,” and may include various entity types, including user, compute instance, resource, or internal service. Authentication involves verifying that a requester's claims about itself are true. Successful authentication results in granting an identity, also referred to as a “principal,” to the requester. A principal may be granted initially to the requester, and may be periodically or intermittently refreshed. For example, an instance principle is an identity assigned to a compute instance. For example, when a virtual machine (VM) is created within a tenancy of the cloud provider, the VM is issued the instance principal. The instance principle can be configured to be assigned to a dynamic group, and policies can be assigned to the dynamic group, which then dictates various permissions associated with the instance. An identity associated with a principal is manifested as a session token granted by the IAM to the requester. Authorization involves verifying that a requester with a certain identity, as evidenced by presentation of the session token, has permission to access a cloud resource. Successful authorization results in permitting the requested access to the requested cloud resource.

As described above, a non-user entity (such as the non-user entities 108, 128) of a cloud environment 100 refers to any of a compute instance, a cloud resource, or a service within the cloud environment. Similarly, a non-user principal refers to a principal assigned to a non-user entity of the cloud environment, such as a principal assigned to a compute instance, a resource, or a service of the cloud environment. Accordingly, a non-user principal comprises any of an instance principal, a resource principal, or a service principal. In contrast, a user principal is assigned to a user of the cloud environment. For example, in FIG. 1, a non-user principal 112 is assigned to a non-user entity 108 of the tenancy 104 of the cloud environment, e.g., by the IAM service 148.

In an example, a non-user principal can be stolen, e.g., when the underlying non-user entity within the cloud environment requests authorization for the corresponding principal. Note that by stealing a non-user principal (such as an instant principal), a malicious actor can attempt to perform malicious acts, such as attempt to exfiltrate data from one tenancy to another tenancy within a cloud region of a cloud environment.

For example, in FIG. 1, a malicious actor steals the non-user principal 112 originally intended for the non-user entity 108, and uses the non-user principal 112 for the non-user entity 128. Thus, the non-user entity 128 can pretend to be the non-user entity 108 using the non-user principal 112. For example, now that the non-user entity 128 has the stolen non-use principal 112, the non-user entity 128 may have access to services and resources that are originally intended for the non-user entity 108 having the principal. One example of a principal being stolen is described in co-pending U.S. patent application Ser. No. 18/895,085, entitled “DETECTING INTER-TENANCY EXFILTRATION IN A CLOUD ENVIRONMENT,” filed Sep. 24, 2024, which is incorporated by references in its entirety.

In an example, the cloud environment 100 comprises the stolen principal detection service 140 configured to detect the stealing of the non-user principal 112. For example, the stolen principal detection service 140 may implement techniques to detect stealing of the non-user principal 112. Example techniques to detect stealing of non-user principals are described in co-pending U.S. patent application Ser. No. 18/895,089, entitled “DETECTING STEALING OF PRINCIPALS IN A CLOUD ENVIRONMENT,” filed Sep. 24, 2024, which is incorporated by references in its entirety.

In an example, the cloud environment 100 also includes a stolen principal containment service 144. The stolen principal containment service 144 undertakes corrective and containment actions, in response to detection of a stolen non-user principal, such as the stolen non-user principal 112. For example, in response to detection of a stolen non-user principal, if an associated dynamic group of cloud resources (e.g., which includes the cloud resources for which the principal is stolen) is removed or deactivated or deleted, this may interrupt the service offered to one or more cloud customers. Thus, corrective actions to be undertaken, in response to detection of a stolen non-user principal, have to be judiciously chosen, so as to balance between interrupting the cloud services offered by the cloud provider and the risks associated with the stolen non-user principal. Containment and corrective actions, in response to detection of a stolen non-user principal, may be based on a variety of factors, such as a type of the non-user entity (such as a compute instance, a resource, or a service) for which a corresponding non-user principal has been stolen, whether the stolen non-user principal belongs to a dynamic group, whether a tenancy to which the stolen non-user principal was originally issued is a white-listed tenancy, and/or the like, as described below in further detail.

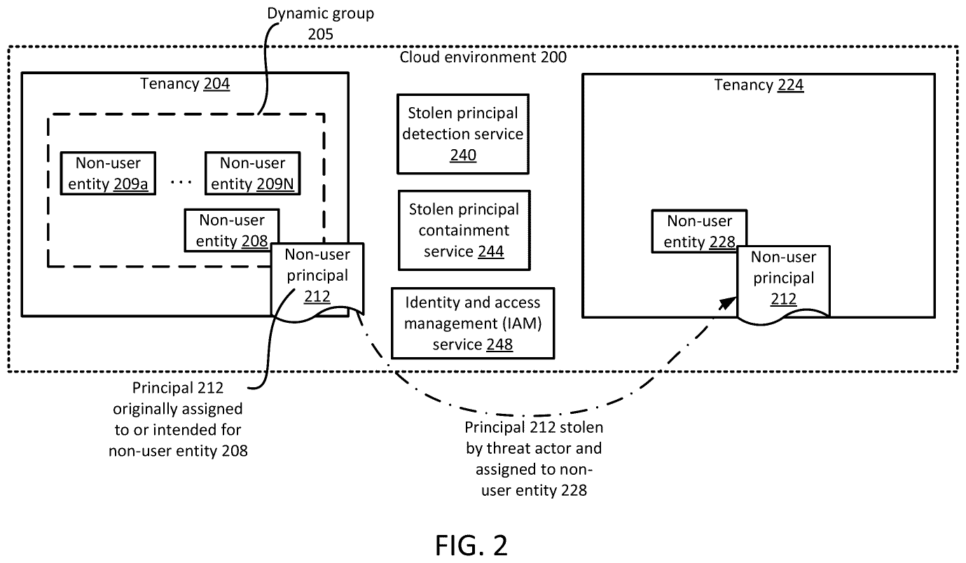

FIG. 2 illustrates an example in which a stolen non-user principal is originally assigned to a dynamic group of non-user entities within a tenancy of a cloud environment 200. The cloud environment 200 includes the tenancy 204 including a plurality of non-user entities 209a, . . . , 209N and 208. The non-user entities 209a, . . . , 209N and 208 are grouped in a dynamic group 205. In a cloud environment, a dynamic group is a logical division comprising a plurality of cloud resources, such that specific policies and permissions are assigned to the cloud resources within the dynamic group. For example, one or more policies for the dynamic group 205 may be created, which may permit non-user entities 208, 209a, . . . , 209N within the dynamic group 205 to make API calls against services, where the policy references the group name. Thus, instead of creating and assigning policies for individual members of the dynamic group 205, a single set of policies are assigned to all members of the dynamic group 205, which facilitates in streamlining formulation and maintenance of policies for cloud resources within the cloud environment 200. A group may be “dynamic” in nature, such that non-user entities may be added dynamically to the group, or deleted dynamically from the group. Thus, non-user entities may be dynamically added and/or removed from the dynamic group 205.

As illustrated, a non-user principal 212 originally assigned to the non-user entity 208 of the dynamic group 205 of the tenancy 204 is stolen and used by another non-user entity 228 within another tenancy 228. Containment action for non-user principals assigned to dynamic groups have been described below in further detail.

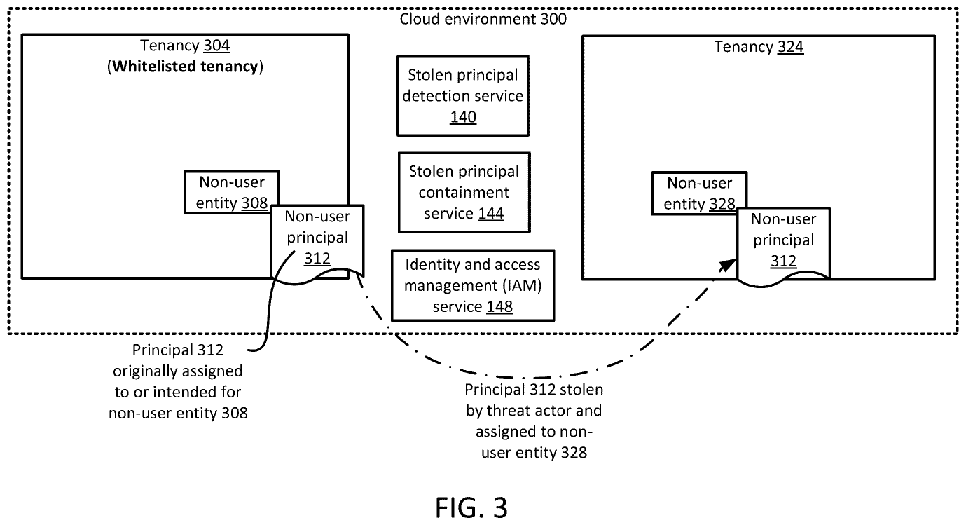

FIG. 3 illustrates an example in which a stolen non-user principal is originally assigned to a non-user entity of a whitelisted tenancy 304 within a cloud environment 300. The cloud environment 300 includes the tenancy 304, which includes the non-user entity 308, wherein the non-user principal 312 is originally assigned to the non-user entity 308. The non-user principal 312 is stolen and used by another non-user entity 328 within another tenancy 324.

In an example, the tenancy 304 is a whitelisted tenancy. A “whitelisted tenancy” is a tenancy used, for example, by security, development, and/or testing teams of the provider of the cloud environment (or by clients having trust of the cloud provider), such that requests from service principal within the whitelisted tenancy are usually honored. For example, tenancy restrictions for whitelisted tenancy are relatively less compared to other non-whitelisted tenancy. Thus, a non-user entity (such as the non-user entity 308) within a whitelisted tenancy (such as the whitelisted tenancy 304) has greater freedom (e.g., compared to non-user entities within non-whitelisted tenancies) to operate on one or more other tenancies of the cloud environment 300. Because the tenancy 304 is a whitelisted tenancy, the tenancy 304, including the non-user entity 308 within the tenancy 304, has greater freedom (e.g., compared to non-user entities within non-whitelisted tenancies) to operate on one or more other tenancies of the cloud environment 300. Thus, if a non-user principal of a whitelisted tenancy 304 is stolen, the stolen non-user principal (such as the non-user principal 312) has relatively higher chances of causing more damage and causing malicious actions on cloud resources within the cloud environment 300.

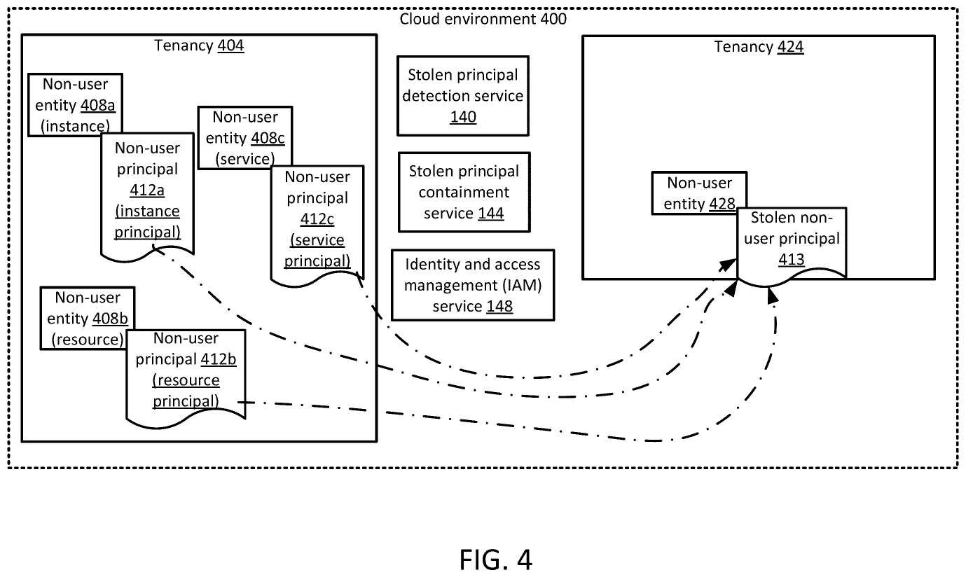

FIG. 4 illustrates an example in which a stolen non-user principal may be any of an instance principal, a resource principal, or a service principal of a cloud environment 400. For example, the cloud environment 400 includes the tenancy 404, which includes non-user entities 408a, 408b, 408c. The non-user entity 408a is a compute instance and a corresponding non-user principal 412a is an instance principal. The non-user entity 408b is a resource and a corresponding non-user principal 412b is a resource principal. The non-user entity 408c is a service and a corresponding non-user principal 412c is a service principal.

Any of the non-user principals 412a, 412b, 412c may be stolen, and the stolen non-user principal (labelled also as 413 in FIG. 4) may be used by a non-user entity 428 of the tenancy 424. For example, if the non-user instance principal 412a is stolen and used by the non-user entity 428, then the non-user entity 428 is a compute instance. If the non-user resource principal 412b is stolen and used by the non-user entity 428, then the non-user entity 428 is a resource. Similarly, for example, if the non-user service principal 412c is stolen and used by the non-user entity 428, then the non-user entity 428 is a cloud service. Thus, the non-user principal that is stolen can be an instance principal, a resource principal, or a service principal.

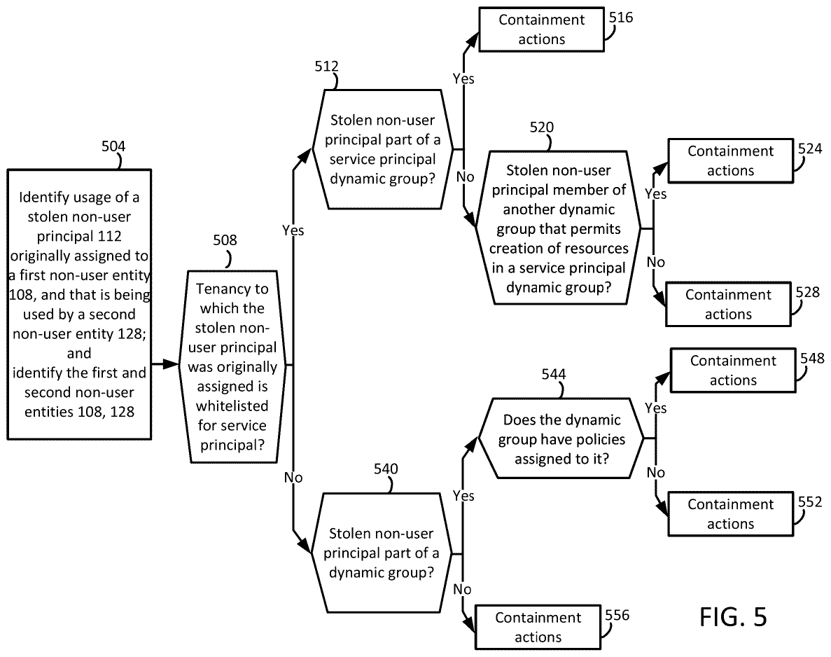

FIG. 5 illustrates a flowchart depicting a method 500 for containment actions to be undertaken, based on detection of a stolen non-user principal. In an example, the method 500 may be applicable to any of the cloud environments 100-400 of FIGS. 1-4 described above. Merely as an example, at least some of the discussion with respect to FIG. 5 pertains to the cloud environment 100 of FIG. 1.

At 504, usage of a stolen non-user principal 112 is identified, e.g., by the stolen principal detection service 140. In an example, the stolen non-user principal 112 is originally assigned to a first non-user entity 108, and is being used by a second non-user entity 128, as described above with respect to FIG. 1.

Also at 504, the first and second non-user entities 108, 128 are identified. For example, the suspicious non-user entity using the stolen principal is attributed to a specific tenancy (e.g., which is the tenancy 124 in the example of FIG. 1). For example, an identification (ID) of the non-user entity using the stolen non-user principal may be determined. The ID may be an instance ID, a resource ID, or a service ID, depending on whether the non-user entity is a compute instance, a resource, or a service. In an example, an IP address and/or one or more other identifier(s) that may be tied back to a tenancy including the non-user entity may be identified. Thus, the tenancy including the non-user entity (e.g., which uses the stolen non-user principal) is identified. Similarly, the non-user entity, to whom the stolen non-user principal was originally assigned, is also identified, where in the example of FIG. 1 the non-user entity is 108 within the tenancy 104.

Thus, in an example, a name and ID of the tenancy including the first non-user entity 108 is identified. In an example, a compartment, a subset, a virtual cloud network (VCN), and/or a cloud region including the first non-user entity 108 are also identified. Similar information may also be gathered for the second non-user entity 128.

As described above, the non-user entity may be an instance, a resource, or a service. If the cloud resource is a compute instance, then a query may be initiated to identify the tenancy including the compute instance, using one or more of (i) an ID of the compute instance, (ii) an IP address of the compute instance. If the cloud resource is a resource of the cloud environment, then the resource principal name may be used in the query. Then the resource principal name (or another resource attribute) may be used to derive an associated tenancy name. Similarly, the owner tenancy may be determined for a service principal as well.

At 508, a determination is made as to whether a tenancy, to which the stolen non-user principal was originally assigned, is whitelisted for service principal. For example, referring to FIG. 1, the stolen son-user principal 112 was originally assigned to the tenancy 104. Thus, a determination is made as to whether the tenancy 104 is whitelisted for service principal. As described above with respect to FIG. 3, a whitelisted tenancy is a tenancy used, for example, by security, development, and/or testing teams of the provider of the cloud environment (or by clients having trust of the cloud provider), such that requests from service principal within the whitelisted tenancy are usually honored (e.g., compared to honoring of requests from service principals within non-whitelisted tenancies). For example, tenancy restrictions for whitelisted tenancy are relatively less compared to other tenancy.

For example, the stolen principal containment service 144 identifies whether the tenancy is whitelisted for a service principal. In an example, the stolen principal containment service 144 also identifies the service principals that the tenancy is whitelisted for.

If the tenancy is whitelisted for a service principal usage, the non-user entity having the stolen non-user principal can possibly cause more damage (e.g., than a scenario in which the tenancy is not whitelisted). For example, non-user entities within the whitelisted tenancy can operate over multiple tenancies per region of the cloud environment, as such whitelisted tenancy may be used internally by the cloud provider for security, development, and/or testing purposes across the cloud environment. In contrast, a non-whitelisted tenancy can have limited access to other tenancies of the cloud environment (e.g., a customer tenancy may not have access to tenancies of other customers). Thus, for example, referring to FIG. 3, if the non-user entity 328 uses the stolen non-user principal 312 of a whitelisted tenancy 304 and operates as the non-user entity 308, the non-user entity 328 may possibly or potentially cause more damage due to the whitelisting status of the tenancy 304 (e.g., compared to a scenario where the tenancy 304 is a non-whitelisted tenancy).

Similarly, in an example, a stolen service principal may possibly cause more damage than a stolen instance principal or a stolen resource principal. For example, a service principal may be used by the provider of the cloud environment, e.g., to provide one or more services across multiple tenancies of the cloud environment. In contrast, outreach of a compute instance with a stolen instance principal may be limited.

For example, if a stolen non-user principal is an instance principal, then the tenancy including the compute instance is analyzed, assessed, and/or investigated for potential abuse. However, if a stolen non-user principal is a service principal, then the tenancy including the service entity, as well as one or more other tenancies to which the service entity provided service, are analyzed, assessed, and/or investigated for potential abuse. Thus, referring to FIG. 1, if the stolen non-user principal 112 is an instance principal or a resource principal, then the tenancies 104 and/or 124 are analyzed, assessed, and/or investigated for potential abuse. On the other hand, if the stolen non-user principal 112 is a service principal, then all the tenancies of the cloud environment 100, which received service from the service using the stolen service principal, are analyzed, assessed, and/or investigated for potential abuse.

Accordingly, summarizing the above description, at 508, it is determined if the owner tenancy to which the stolen non-user principal was originally assigned, is whitelisted for service principal. If “Yes” at 508, the method 500 proceeds to block 512; else the method 500 proceeds to block 540.

At 512, a determination is made (e.g., by the stolen principal containment service 144) as to whether the stolen non-user principal is part of a service principal dynamic group. As described above with respect to FIG. 2, in a cloud environment, a dynamic group is a logical division comprising a plurality of cloud resources, such that specific policies and permissions are assigned to the cloud resources within the dynamic group. Thus, at 512, a dynamic group, if associated with the stolen non-user principal, is identified.

In an example, a dynamic group includes all non-user entities within a compartment of a tenancy, and the group members are “all instances, services, and/or resources of the compartment XYZ or tenancy XYZ,” where XYZ is an identifier of a compartment or a tenancy. In another example, a dynamic group may specifically identity one or more non-user entities, such as compute instances ABC and DEF within a compartment or tenancy XYZ, where ABC and DEF are identifiers of compute instances.

If Yes” at 512, containment actions 516 are undertaken. For example, if a non-user entity using a stolen non-user principal is part of a dynamic group, containment actions may include any of (i) deleting the stolen non-user principal, (ii) taking the non-user entity off the dynamic group, such that the non-user entity no longer enjoys privileges accorded to the members of the dynamic group, (iii) changing the policies of the dynamic group, such that members of the dynamic group may no longer carry out malicious activities while being part of the dynamic group, and/or (iv) deleting the dynamic group altogether. Note that the options (iii) and (iv) affect all members of the group, such as members of the group that did not use any stolen principal. Also, note that for option (ii), no refresh of the group may be needed, as the group is dynamic in nature.

If “No” at 512, the method 500 proceeds to block 520. At 520, a determination is made (e.g., by the stolen principal containment service 144) as to whether the stolen non-user principal is a member of another dynamic group that permits creation of resources in a service principal dynamic group. If “Yes” at 520 (e.g., the stolen non-user principal is a member of a dynamic group that permits creation of resources in a service principal dynamic group), this implies that the stolen non-user principal may have created one or more resources in the service principal dynamic group. Accordingly, if “Yes” at 520, the method 500 proceeds to containment actions at 524. In an example, stringent containment actions may be undertaken at 524, such as deleting all non-user entities of the dynamic group, deleting the dynamic group, etc. This may at least in part disrupt services provided by the dynamic group. But such actions may contain possible malicious activities and damage caused by the stolen non-user principal. In an example, any resource created by the malicious non-user entity (e.g., using the stolen principal) are investigated for possible anomalous issues.

If “No” at 520, then the stolen non-user principal is not a member of a dynamic group, and containment actions 528 are undertaken. Accordingly, any possible damage caused by the stolen non-user principal may not affect a dynamic group. In an example, the containment actions 528 includes deleting the stolen non-user principal.

Referring back to the block 508, if “No” at 508, then the tenancy to which the stolen non-user principal was originally assigned is not whitelisted for service principal, and the method 500 proceeds to 540. At 540, a determination is made (e.g., by the stolen principal containment service 144) as to whether the stolen non-user principal is part of a dynamic group. If “No” at 540, then the stolen non-user principal is not a member of a dynamic group, and containment actions 556 are undertaken. Any possible damage caused by the stolen non-user principal may not affect a dynamic group. In an example, the containment actions 556 includes deleting the stolen non-user principal.

Also, if “Yes” at 540, then the tenancy to which the stolen non-user principal is a part of a dynamic group, and the method 500 proceeds from 540 to 544. At 544, a determination is made (e.g., by the stolen principal containment service 144) as to whether the dynamic group (which includes the stolen non-user principal) have policies assigned to the dynamic group. If “No” at 544, then the stolen non-user principal is a member of a dynamic group that does not have policies assigned to it, and containment actions 552 are undertaken. Any possible damage caused by the stolen non-user principal may not affect the dynamic group, as the dynamic group did not have policies assigned to it. In an example, the containment actions 552 includes deleting the stolen non-user principal.

If “Yes” at 544, then the stolen non-user principal is a member of a dynamic group that has one or more policies assigned to it, and containment actions 548 are undertaken. For example, containment actions may include any of (i) deleting the stolen non-user principal, (ii) taking the non-user entity off the dynamic group, such that the non-user entity no longer enjoys privileges accorded to the members of the dynamic group, (iii) changing the policies of the dynamic group, such that the non-user entity may no longer carry out malicious activities while being part of the dynamic group, and/or (iv) deleting the dynamic group altogether. Note that the options (iii) and (iv) affect all members of the group, such as members of the group that did not use any stolen principal. Also, note that for option (ii), no refresh of the group may be needed, as the group is dynamic in nature.

As described above, the containment actions at 516, 524, 528, 548, 552, and/or 556 are based on one or more factors, such as whether the original tenancy of the stolen non-user principal is a whitelisted tenancy, whether the stolen non-user principal a part of a dynamic group, whether the stolen non-user principal a part of a service principal dynamic group, whether the stolen non-user principal a part of a dynamic group that have policies assigned to it, whether the stolen non-user principal a part of a dynamic group that permits creation of resources in a service principal dynamic group, and/or the like. In an example, containment actions may also be based on one or more other factors, such as based on a determination as to whether one or more additional resources have been created by the stolen non-user principal, whether one or more other persistence mechanisms were created, a type of the stolen non-user principal (e.g., whether the stolen non-user principal is an instance principal, a resource principal, or a service principal), and/or whether the stolen non-user principal has cross-tenancy and cross-cloud region access capabilities.

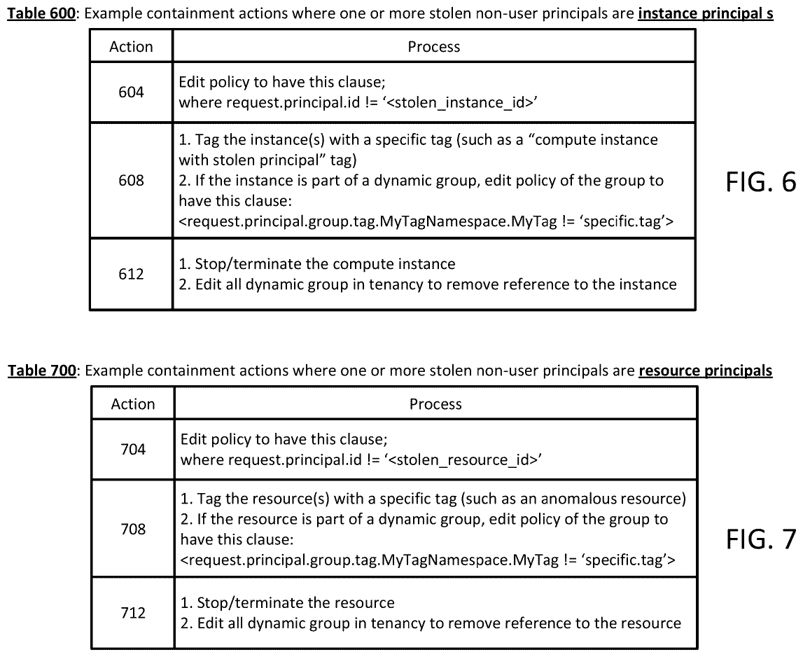

FIG. 6 illustrates a table 600 depicting example containment actions, e.g., when one or more stolen non-user principals are instance principals. Three rows of table 600 illustrates three example containment actions 604, 608, and 612.

Action 604 involves editing a policy associated with the stolen non-user principal for a dynamic group as: where request.principal.id !=‘<stolen_instance_id>’. Here, the stolen_instance_id is an identification of the stolen non-user instance principal. This policy ensures that a principal ID within a dynamic group cannot be equal to the ID of the stolen non-user instance principal. Thus, the compute instance having the stolen_instance_id is effectively taken out of the dynamic group.

Action 608 involves tagging one or more instances (e.g., which uses stolen non-user instance principals) with a pre-agreed specific tag (such as “compute instance with stolen principal” tag and another appropriate tag). If the instances are part of a dynamic group, the policy of the dynamic group may be edited as follows: <request.principal.group.tag.MyTagNamespace.MyTag !=‘specific.tag’>. Thus, one or more compute instances using the stolen non-user principles are tagged with a specific pre-agreed tag. Subsequently, all instances within a dynamic group, which match the specific tag, are taken out of the dynamic group.

Note that actions 604 and 608 described above have the same effect of taking one or more compute instances out of the dynamic group. Thus, the actions 604 and 608 provide two approaches, with same results (e.g., taking one or more compute instances out of a dynamic group). In an example, the action 604 may be relatively quicker for isolation and may be used when a relatively lower number of compute instances are detected to be using stolen principals and are to be taken off the dynamic group, whereas action 608 may be preferable for bulk removal of compute instances that are using stolen principals.

Action 612 involves stopping and/or terminating the compute instances using stolen non-user principals, and editing one or more dynamic groups in a tenancy to remove reference to the such compute instances. Thus, action 612 is a generic version of actions 604 and 608, e.g., actions 604, 608 may be specific examples of editing one or more dynamic groups in a tenancy to remove reference to compute instances using stolen non-user principals.

FIG. 7 illustrates a table 700 depicting example containment actions, e.g., when one or more stolen non-user principals are resource principals. Three rows of table 700 illustrates three example containment actions 704, 708, and 712.

In an example, actions 704, 708, 712 are similar to actions 604, 608, 612, respectively, except for the fact that the actions 604, 608, 612 are for instance principals, whereas the actions 704, 708, 712 are for resource principals. The actions 704, 708, 712 will be apparent in view of the above description with respect to the actions 604, 608, 612.

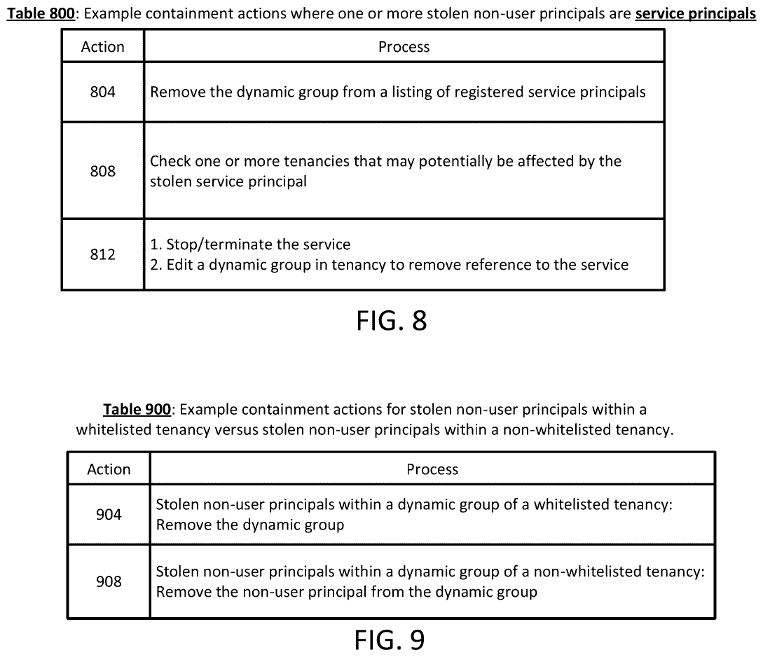

FIG. 8 illustrates a table 800 depicting example containment actions, e.g., when one or more stolen non-user principals are service principal. Three rows of table 800 illustrates three example containment actions 804 and 808, and 812. Action 804 involves removing the dynamic group (which includes one or more stolen non-user service principals) from a listing of registered service principals. Thus, in this case, instead of removing an individual service (e.g., that utilizes the stolen non-user principal) from a dynamic group, the entire dynamic group is removed or deleted. This action may cause an outage of an entire service within a specific realm of the cloud environment.

Note that in an example, for a stolen instance principal and/or a stolen resource principal, the corresponding compute instance and/or the corresponding resource may be taken out of the dynamic group (e.g., see FIGS. 6 and 7). In contrast, for a stolen service principal, in an example, the entire dynamic group including the service principal may be disabled or removed (e.g., access permissions to services within the dynamic group is rescinded). Such differential containment actions between the instance and resource principals versus the service principals may be because of the following reasons. Service principals comprise an internally used principal type for services that usually have a broad swathe of privileges and may affect a larger number of cloud resources. Therefore an urgency required to resolve a situation where a service principal is required is relatively higher (compared to a scenario involving an instance or a resource principal). Disabling the whole dynamic group including the identified service may cause relatively larger disruptive impact on the cloud environment (e.g., compared to removing a single compute instance or a single resource from the dynamic group). However, due to the possibility of other services within the dynamic group also being affected and/or due to the possibility of the relatively large number of cloud entities being possibly affected by the one or more services, such extreme actions are taken based on identifying stolen service principal(s), while similar drastic actions may not be undertaken based on identifying stolen instance and/or resource principals. Accordingly, the action 804 involves removing the entire dynamic group including the stolen non-user service principal.

Action 808 involves check one or more tenancies that may potentially be affected by the stolen non-user service principal. For example, services are often operated by the provided of the cloud environment, and services may affect many different compute instances and/or resources in multiple customer tenancies of the cloud environment. Accordingly, action 808 includes checking compute instances, resources, and/or services within one or more tenancies, on which the compromised service may have acted on in the past. Note that both actions 804 and 808 may be executed, such as at least in part in parallel or in a sequence.

Action 812 involves stopping and/or terminating the service using stolen non-user service principals, and editing one or more dynamic groups in a tenancy to remove reference to the such services. However, in an example, for reasons described above, action 804 may be preferred over action 812 for stolen service principals.

FIG. 9 illustrates a table 900 depicting example containment actions for stolen non-user principals within a whitelisted tenancy versus stolen non-user principals within a non-whitelisted tenancy.

Action 904 pertains to an example in which the stolen non-user principals are originally assigned to non-user entities within a dynamic group of a whitelisted tenancy. In contrast, action 908 pertains to another example in which the stolen non-user principals are originally assigned to non-user entities within a dynamic group of a non-whitelisted tenancy.

Because the action 904 pertains to stolen non-user principals of whitelisted tenancy, in an example, the action 904 is more stringent than the action 908, e.g., for reasons described herein above. For example, for action 904, the entire dynamic group is removed or deleted (e.g., similar to action 804 of table 800). In contrast, for action 908, the non-user principal is removed or deleted from the dynamic group (e.g., similar to actions 604, 608, and 612 of table 600).

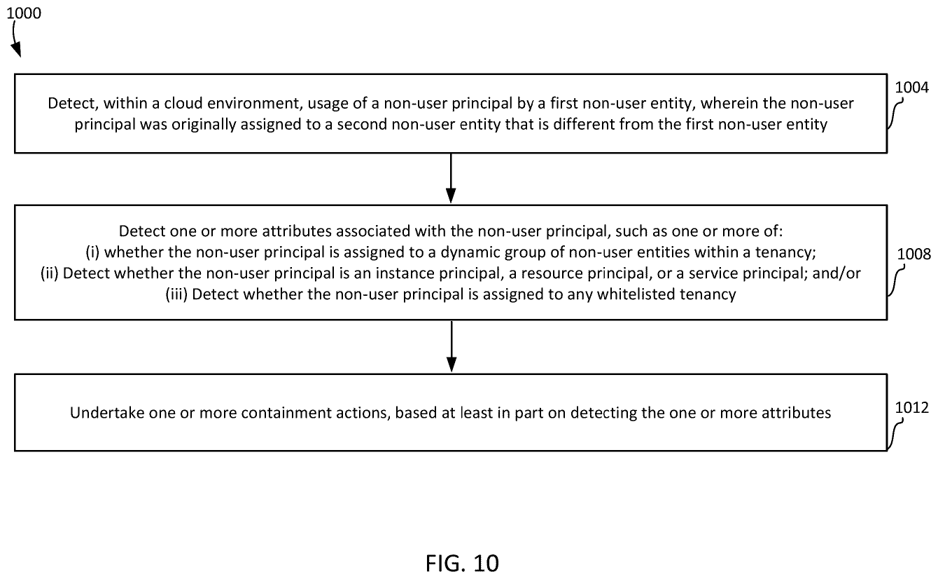

FIG. 10 illustrates a flow chart depicting another method 1000 for containment actions to be undertaken, based on detection of a stolen non-user principal. At 1004, within a cloud environment, usage of a non-user principal by a first non-user entity is detected, wherein the non-user principal was originally assigned to a second non-user entity that is different from the first non-user entity. Thus, the first non-user entity is using a stolen non-user principal that was originally assigned to the second non-user entity. In an example, the detection may be performed by the stolen principal detection service 140.

At 1008, one or more attributes associated with the non-user principal are detected, such as one or more of (i) whether the non-user principal is assigned to a dynamic group of non-user entities within a tenancy, (ii) whether the non-user principal is an instance principal, a resource principal, or a service principal, and/or (iii) whether the non-user principal is assigned to any whitelisted tenancy. In an example, the detections at 1008 may be performed by the stolen principal detection service 140 and/or the stolen principal containment service 144. The detections at 1008 are described above with respect to FIG. 5.

At 1012, one or more one or more containment actions are undertaken, based at least in part on detecting the one or more attributes, such as based at least in part on one or more of (i) whether the non-user principal is assigned to a dynamic group of non-user entities within a tenancy, (ii) whether the non-user principal is an instance principal, a resource principal, or a service principal, and (iii) whether the non-user principal is assigned to any whitelisted tenancy. The containment actions are described above in further detail, e.g., with respect to FIGS. 5-10.

### Computer System Architecture

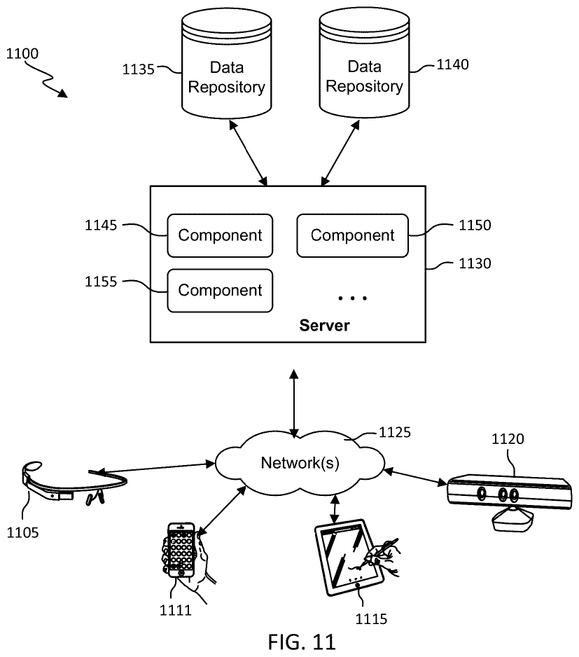

FIG. 11 depicts a simplified diagram of a distributed system 1100 for implementing an embodiment. In the illustrated embodiment, distributed system 1100 includes one or more client computing devices 1102, 1104, 1106, 1108, and/or 1110 coupled to a server 1114 via one or more communication networks 1112. Clients computing devices 1102, 1104, 1106, 1108, and/or 1110 may be configured to execute one or more applications.

In various aspects, server 1114 may be adapted to run one or more services or software applications that enable techniques for undertaking containment actions in response to detection of stealing of non-user principals within a cloud environment.

In certain aspects, server 1114 may also provide other services or software applications that can include non-virtual and virtual environments. In some aspects, these services may be offered as web-based or cloud services, such as under a Software as a Service (SaaS) model to the users of client computing devices 1102, 1104, 1106, 1108, and/or 1110. Users operating client computing devices 1102, 1104, 1106, 1108, and/or 1110 may in turn utilize one or more client applications to interact with server 1114 to utilize the services provided by these components.

In the configuration depicted in FIG. 11, server 1114 may include one or more components 1120, 1122 and 1124 that implement the functions performed by server 1114. These components may include software components that may be executed by one or more processors, hardware components, or combinations thereof. It should be appreciated that various different system configurations are possible, which may be different from distributed system 1100. The embodiment shown in FIG. 11 is thus one example of a distributed system for implementing an embodiment system and is not intended to be limiting.

Users may use client computing devices 1102, 1104, 1106, 1108, and/or 1110 for techniques for undertaking containment actions in response to detection of stealing of non-user principals within a cloud environment in accordance with the teachings of this disclosure. A client device may provide an interface that enables a user of the client device to interact with the client device. The client device may also output information to the user via this interface. Although FIG. 11 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1112 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1112 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1114 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1114 can include one or more virtual machines running virtual operating systems, or other computing architectures involving virtualization such as one or more flexible pools of logical storage devices that can be virtualized to maintain virtual storage devices for the server. In various aspects, server 1114 may be adapted to run one or more services or software applications that provide the functionality described in the foregoing disclosure.

The computing systems in server 1114 may run one or more operating systems including any of those discussed above, as well as any commercially available server operating system. Server 1114 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1114 may include one or more applications to analyze and consolidate data feeds and/or event updates received from users of client computing devices 1102, 1104, 1106, 1108, and/or 1110. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1114 may also include one or more applications to display the data feeds and/or real-time events via one or more display devices of client computing devices 1102, 1104, 1106, 1108, and/or 1110.

Distributed system 1100 may also include one or more data repositories 1116, 1118. These data repositories may be used to store data and other information in certain aspects. For example, one or more of the data repositories 1116, 1118 may be used to store information for techniques for undertaking containment actions in response to detection of stealing of non-user principals within a cloud environment. Data repositories 1116, 1118 may reside in a variety of locations. For example, a data repository used by server 1114 may be local to server 1114 or may be remote from server 1114 and in communication with server 1114 via a network-based or dedicated connection. Data repositories 1116, 1118 may be of different types. In certain aspects, a data repository used by server 1114 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1116, 1118 may also be used by applications to store application data. The data repositories used by applications may be of different types such as, for example, a key-value store repository, an object store repository, or a general storage repository supported by a file system.

In one embodiment, server 1114 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

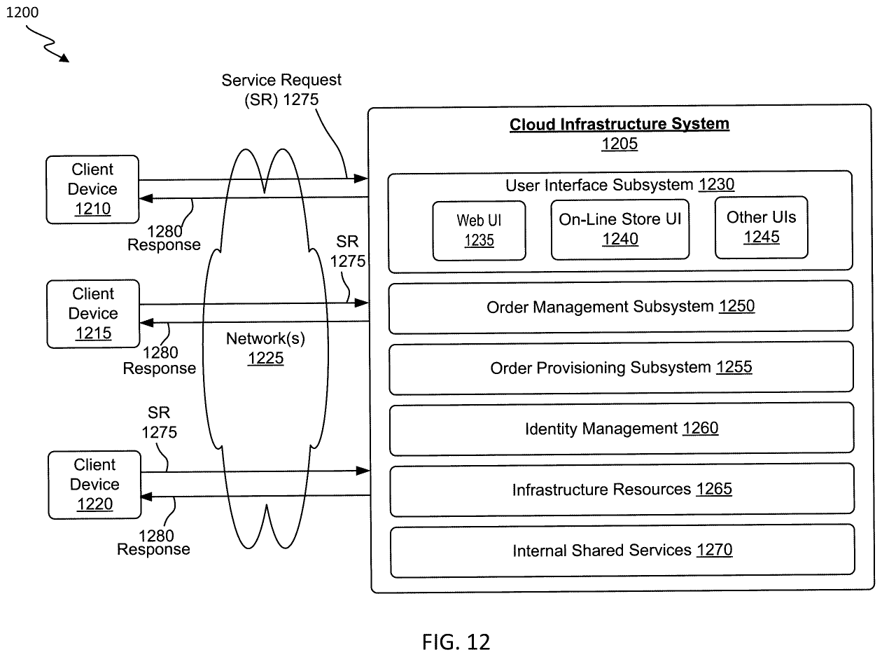

FIG. 12 is a simplified block diagram of a cloud-based system environment in which disclosed are techniques for undertaking containment actions in response to detection of stealing of non-user principals within a cloud environment, in accordance with certain aspects. In the embodiment depicted in FIG. 12, cloud infrastructure system 1202 may provide one or more cloud services that may be requested by users using one or more client computing devices 1204, 1206, and 1208. Cloud infrastructure system 1202 may comprise one or more computers and/or servers that may include those described above for server 1114. The computers in cloud infrastructure system 1202 may be organized as general purpose computers, specialized server computers, server farms, server clusters, or any other appropriate arrangement and/or combination.

Network(s) 1210 may facilitate communication and exchange of data between clients 1204, 1206, and 1208 and cloud infrastructure system 1202. Network(s) 1210 may include one or more networks. The networks may be of the same or different types. Network(s) 1210 may support one or more communication protocols, including wired and/or wireless protocols, for facilitating the communications.

The embodiment depicted in FIG. 12 is only one example of a cloud infrastructure system and is not intended to be limiting. It should be appreciated that, in some other aspects, cloud infrastructure system 1202 may have more or fewer components than those depicted in FIG. 12, may combine two or more components, or may have a different configuration or arrangement of components. For example, although FIG. 12 depicts three client computing devices, any number of client computing devices may be supported in alternative aspects.

The term cloud service is generally used to refer to a service that is made available to users on demand and via a communication network such as the Internet by systems (e.g., cloud infrastructure system 1202) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1210 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1202 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1202 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1202. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1202. Cloud infrastructure system 1202 then performs processing to provide the services requested in the tenant's subscription order. Cloud infrastructure system 1202 may be configured to provide one or even multiple cloud services.

Cloud infrastructure system 1202 may provide the cloud services via different deployment models. In a public cloud model, cloud infrastructure system 1202 may be owned by a third party cloud services provider and the cloud services are offered to any general public tenant, where the tenant can be an individual or an enterprise. In certain other aspects, under a private cloud model, cloud infrastructure system 1202 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1202 and the services provided may be shared by several organizations in a related community. Various other models such as hybrids of the above mentioned models may also be used.

Client computing devices 1204, 1206, and 1208 may be of different types (such as devices 1102, 1104, 1106, and 1108 depicted in FIG. 11) and may be capable of operating one or more client applications. A user may use a client device to interact with cloud infrastructure system 1202, such as to request a service provided by cloud infrastructure system 1202.

In some aspects, the processing performed by cloud infrastructure system 1202 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1202 for determining the intent of an utterance. The data used for this analysis may include structured data (e.g., data stored in a database or structured according to a structured model) and/or unstructured data (e.g., data blobs (binary large objects)).

As depicted in the embodiment in FIG. 12, cloud infrastructure system 1202 may include infrastructure resources 1230 that are utilized for facilitating the provision of various cloud services offered by cloud infrastructure system 1202. Infrastructure resources 1230 may include, for example, processing resources, storage or memory resources, networking resources, and the like.

In certain aspects, to facilitate efficient provisioning of these resources for supporting the various cloud services provided by cloud infrastructure system 1202 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1202 may itself internally use services 1232 that are shared by different components of cloud infrastructure system 1202 and which facilitate the provisioning of services by cloud infrastructure system 1202. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1202 may comprise multiple subsystems. These subsystems may be implemented in software, or hardware, or combinations thereof. As depicted in FIG. 12, the subsystems may include a user interface subsystem 1212 that enables users of cloud infrastructure system 1202 to interact with cloud infrastructure system 1202. User interface subsystem 1212 may include various different interfaces such as a web interface 1214, an online store interface 1216 where cloud services provided by cloud infrastructure system 1202 are advertised and are purchasable by a consumer, and other interfaces 1218. For example, a tenant may, using a client device, request (service request 1234) one or more services provided by cloud infrastructure system 1202 using one or more of interfaces 1214, 1216, and 1218. For example, a tenant may access the online store, browse cloud services offered by cloud infrastructure system 1202, and place a subscription order for one or more services offered by cloud infrastructure system 1202 that the tenant wishes to subscribe to. The service request may include information identifying the tenant and one or more services that the tenant desires to subscribe to. For example, a tenant may place a subscription order for a chatbot related service offered by cloud infrastructure system 1202. As part of the order, the client may provide information identifying the input (e.g. utterances).

In certain aspects, such as the embodiment depicted in FIG. 12, cloud infrastructure system 1202 may comprise a service management subsystem (OMS) 1220 that is configured to process the new order. As part of this processing, OMS 1220 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1220 may then invoke the service provisioning subsystem (OPS) 1224 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1224 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1202 may send a response or notification 1244 to the requesting tenant to indicate when the requested service is now ready for use. In some instances, information (e.g., a link) may be sent to the tenant that enables the tenant to start using and availing the benefits of the requested services.

Cloud infrastructure system 1202 may provide services to multiple tenants. For each tenant, cloud infrastructure system 1202 is responsible for managing information related to one or more subscription orders received from the tenant, maintaining tenant data related to the orders, and providing the requested services to the tenant or clients of the tenant. Cloud infrastructure system 1202 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1202 may provide services to multiple tenants in parallel. Cloud infrastructure system 1202 may store information for these tenants, including possibly proprietary information. In certain aspects, cloud infrastructure system 1202 comprises an identity management subsystem (IMS) 1228 that is configured to manage tenant's information and provide the separation of the managed information such that information related to one tenant is not accessible by another tenant. IMS 1228 may be configured to provide various security-related services such as identity services, such as information access management, authentication and authorization services, services for managing tenant identities and roles and related capabilities, and the like.

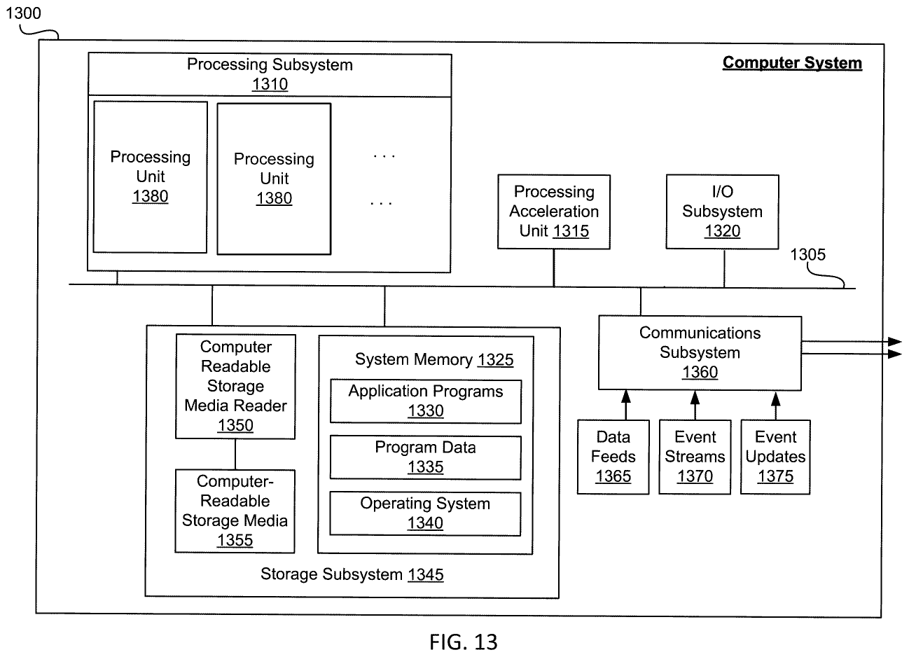

FIG. 13 illustrates an exemplary computer system 1300 that may be used to implement certain aspects. As shown in FIG. 13, computer system 1300 includes various subsystems including a processing subsystem 1304 that communicates with a number of other subsystems via a bus subsystem 1302. These other subsystems may include a processing acceleration unit 1306, an I/O subsystem 1308, a storage subsystem 1318, and a communications subsystem 1324. Storage subsystem 1318 may include non-transitory and/or transitory computer-readable storage media including storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative aspects of the bus subsystem may utilize multiple buses. Bus subsystem 1302 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1304 controls the operation of computer system 1300 and may comprise one or more processors, application specific integrated circuits (ASICs), or field programmable gate arrays (FPGAs). The processors may be single core or multicore processors. The processing resources of computer system 1300 can be organized into one or more processing units 1332, 1334, etc. A processing unit may include one or more processors, one or more cores from the same or different processors, a combination of cores and processors, or other combinations of cores and processors. In some aspects, processing subsystem 1304 can include one or more special purpose co-processors such as graphics processors, digital signal processors (DSPs), or the like. In some aspects, some or all of the processing units of processing subsystem 1304 can be implemented using customized circuits, such as application specific integrated circuits (ASICs), or field programmable gate arrays (FPGAs).

In some aspects, the processing units in processing subsystem 1304 can execute instructions stored in system memory 1310 or on computer readable storage media 1322. In various aspects, the processing units can execute a variety of programs or code instructions and can maintain multiple concurrently executing programs or processes. At any given time, some or all of the program code to be executed can be resident in system memory 1310 and/or on computer-readable storage media 1322 including potentially on one or more storage devices. Through suitable programming, processing subsystem 1304 can provide various functionalities described above. In instances where computer system 1300 is executing one or more virtual machines, one or more processing units may be allocated to each virtual machine.

In certain aspects, a processing acceleration unit 1306 may optionally be provided for performing customized processing or for off-loading some of the processing performed by processing subsystem 1304 so as to accelerate the overall processing performed by computer system 1300.

I/O subsystem 1308 may include devices and mechanisms for inputting information to computer system 1300 and/or for outputting information from or via computer system 1300. In general, use of the term input device is intended to include all possible types of devices and mechanisms for inputting information to computer system 1300. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1300 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1318 provides a repository or data store for storing information and data that is used by computer system 1300. Storage subsystem 1318 provides a tangible non-transitory computer-readable storage medium for storing the basic programming and data constructs that provide the functionality of some aspects. Storage subsystem 1318 may store software (e.g., programs, code modules, instructions) that when executed by processing subsystem 1304 provides the functionality described above. The software may be executed by one or more processing units of processing subsystem 1304. Storage subsystem 1318 may also provide a repository for storing data used in accordance with the teachings of this disclosure.

Storage subsystem 1318 may include one or more non-transitory memory devices, including volatile and non-volatile memory devices. As shown in FIG. 13, storage subsystem 1318 includes a system memory 1310 and a computer-readable storage media 1322. System memory 1310 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1300, such as during start-up, may typically be stored in the ROM. The RAM typically contains data and/or program modules that are presently being operated and executed by processing subsystem 1304. In some implementations, system memory 1310 may include multiple different types of memory, such as static random access memory (SRAM), dynamic random access memory (DRAM), and the like.

By way of example, and not limitation, as depicted in FIG. 13, system memory 1310 may load application programs 1312 that are being executed, which may include various applications such as Web browsers, mid-tier applications, relational database management systems (RDBMS), etc., program data 1314, and an operating system 1316. By way of example, operating system 1316 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1322 may store programming and data constructs that provide the functionality of some aspects. Computer-readable media 1322 may provide storage of computer-readable instructions, data structures, program modules, and other data for computer system 1300. Software (programs, code modules, instructions) that, when executed by processing subsystem 1304 provides the functionality described above, may be stored in storage subsystem 1318. By way of example, computer-readable storage media 1322 may include non-volatile memory such as a hard disk drive, a magnetic disk drive, an optical disk drive such as a CD ROM, digital video disc (DVD), a Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1318 may also include a computer-readable storage media reader 1320 that can further be connected to computer-readable storage media 1322. Reader 1320 may receive and be configured to read data from a memory device such as a disk, a flash drive, etc.

In certain aspects, computer system 1300 may support virtualization technologies, including but not limited to virtualization of processing and memory resources. For example, computer system 1300 may provide support for executing one or more virtual machines. In certain aspects, computer system 1300 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1300. Accordingly, multiple operating systems may potentially be run concurrently by computer system 1300.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to establish a communication channel to one or more client devices via the Internet for receiving and sending information from and to the client devices. For example, the communications subsystem may be used to transmit a response to a user regarding the inquiry for a chatbot.

Communications subsystem 1324 may support both wired and/or wireless communication protocols. For example, in certain aspects, communications subsystem 1324 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1324 can provide wired network connectivity (e.g., Ethernet) in addition to or instead of a wireless interface.

Communications subsystem 1324 can receive and transmit data in various forms. For example, in some aspects, in addition to other forms, communications subsystem 1324 may receive input communications in the form of structured and/or unstructured data feeds 1326, event streams 1328, event updates 1330, and the like. For example, communications subsystem 1324 may be configured to receive (or send) data feeds 1326 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1324 may be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to communicate data from computer system 1300 to other computer systems or networks. The data may be communicated in various different forms such as structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1300 depicted in FIG. 13 is intended only as a specific example. Many other configurations having more or fewer components than the system depicted in FIG. 13 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
detecting, within a cloud environment, usage of a non-user principal by a first non-user entity, wherein the non-user principal was originally assigned to a second non-user entity that is different from the first non-user entity;
detecting one or more attributes associated with the non-user principal; and
undertaking one or more containment actions responsive to detecting the usage of the non-user principal by the first non-user entity, wherein the one or more containment actions are based at least in part on detecting the one or more attributes associated with the non-user principal.

2. The non-transitory computer-readable medium of claim 1, wherein detecting the one or more attributes associated with the non-user principal comprises one or more of:
detecting whether the non-user principal is assigned to a dynamic group of non-user entities within a tenancy; and
detecting whether the non-user principal is an instance principal, a resource principal, or a service principal.

3. The non-transitory computer-readable medium of claim 2, wherein undertaking the one or more containment actions include:
detecting that the non-user principal is a service principal and is assigned to a dynamic group; and
in response to detecting that the non-user principal is a service principal and is assigned to the dynamic group, disabling the dynamic group.

4. The non-transitory computer-readable medium of claim 2, wherein undertaking the one or more containment actions include:
detecting that the non-user principal is a service principal; and
in response to detecting that the non-user principal is a service principal, checking one or more resources within one or more tenancy, to which the first non-user entity provided a service using the service principal, to detect anomalous issues with the one or more resources caused by the first non-user entity.

5. The non-transitory computer-readable medium of claim 2, wherein undertaking the one or more containment actions include:
detecting that (i) the non-user principal is an instance principal or a resource principal and (ii) is assigned to a dynamic group; and
in response to detecting that the non-user principal is an instance principal or a resource principal and is assigned to the dynamic group, removing the non-user principal from the dynamic group.

6. The non-transitory computer-readable medium of claim 5, wherein the non-user principal is a first non-user principal, and wherein removing the first non-user principal from the dynamic group comprises:
tagging each of the first non-user principal and one or more other non-user principals with a pre-specified tag; and
removing each non-user principal, which is tagged with the pre-specified tag, from the dynamic group.

7. The non-transitory computer-readable medium of claim 5, wherein removing the non-user principal from the dynamic group comprises:
editing a policy of the dynamic group, to remove the non-user principal from the dynamic group.

8. The non-transitory computer-readable medium of claim 2, wherein the non-user principal is a first non-user principal, and wherein the operations further include:
detecting, within a cloud environment, usage of a second non-user principal by a third non-user entity, wherein the second non-user principal was originally assigned to a fourth non-user entity that is different from the third non-user entity;
wherein the first non-user principal is a service principal that is assigned to a first dynamic group;
wherein the second non-user principal is a resource principal or an instance principal that is assigned to a second dynamic group;
wherein one or more containment actions for the first non-user principal include disabling the first dynamic group, in response to detecting that the first non-user principal is a service principal; and
wherein one or more containment actions for the second non-user principal include removing the second non-user principal from the second dynamic group, in response to detecting that the second non-user principal is a resource principal or an instance principal.

9. The non-transitory computer-readable medium of claim 2, wherein undertaking the one or more containment actions include:
detecting that the non-user principal is not assigned to any dynamic group; and
in response to detecting that the non-user principal is not assigned to any dynamic group, disabling the non-user principal.

10. The non-transitory computer-readable medium of claim 1, wherein:
detecting the one or more attributes associated with the non-user principal comprises detecting whether the non-user principal is assigned to any whitelisted tenancy; and
the one or more containment actions undertaken are based on detecting whether the non-user principal is assigned to any whitelisted tenancy.

11. The non-transitory computer-readable medium of claim 1, wherein the non-user principal is a first non-user principal, and wherein the operations further include:
detecting, within a cloud environment, usage of a second non-user principal by a third non-user entity, wherein the second non-user principal was originally assigned to a fourth non-user entity that is different from the third non-user entity;
wherein the first non-user principal is assigned to a whitelisted tenancy and to a first dynamic group, and wherein the second non-user principal is assigned to a non-whitelisted tenancy and to a second dynamic group;
wherein one or more containment actions for the first non-user principal include disabling the first dynamic group; and
wherein one or more containment actions for the second non-user principal include removing the second non-user principal from the second dynamic group.

12. The non-transitory computer-readable medium of claim 1, wherein the non-user principal is assigned to the second non-user entity by an identity and access management (IAM) service.

13. The non-transitory computer-readable medium of claim 1, wherein the non-user principal is stolen from the second non-user entity and provided to the first non-user entity.

14. A method comprising:
detecting, within a cloud environment, usage of a non-user principal by a first non-user entity, wherein the non-user principal was originally assigned to a second non-user entity that is different from the first non-user entity;
detecting whether the non-user principal is assigned to a dynamic group of non-user entities within a tenancy;
detecting whether the non-user principal is an instance principal, a resource principal, or a service principal; and
undertaking one or more containment actions, based at least in part on one or both of (i) detecting whether the non-user principal is assigned to the dynamic group of non-user entities and (ii) detecting whether the non-user principal is an instance principal, a resource principal, or a service principal.

15. The method of claim 14, wherein undertaking the one or more containment actions comprises:
detecting that the non-user principal is a service principal and is assigned to a dynamic group; and
in response to detecting that the non-user principal is a service principal and is assigned to the dynamic group, disabling the dynamic group.

16. The method of claim 14, wherein undertaking the one or more containment actions comprises:
detecting that the non-user principal is a service principal; and
in response to detecting that the non-user principal is a service principal, checking one or more resources within one or more tenancy, to which the first non-user entity provided a service using the service principal, to detect anomalous issues with the one or more resources caused by the first non-user entity.

17. The method of claim 14, wherein undertaking the one or more containment actions include:
detecting that (i) the non-user principal is an instance principal or a resource principal and (ii) is assigned to a dynamic group; and
in response to detecting that the non-user principal is an instance principal or a resource principal and is assigned to the dynamic group, removing the non-user principal from the dynamic group.

18. A system comprising:
one or more processors; and
one or more non-transitory computer-readable media storing instructions, which, when executed by the system, cause the system to perform a set of actions including:
detecting, within a cloud environment, usage of a non-user principal by a first non-user entity, wherein the non-user principal was originally assigned to a second non-user entity that is different from the first non-user entity;
detecting whether the non-user principal is assigned to a dynamic group of non-user entities within a tenancy;
detecting whether the non-user principal is an instance principal, a resource principal, or a service principal; and
undertaking one or more containment actions, based at least in part on one or both of (i) detecting whether the non-user principal is assigned to the dynamic group of non-user entities and (ii) detecting whether the non-user principal is an instance principal, a resource principal, or a service principal.

19. The system of claim 18, wherein undertaking the one or more containment actions comprises:
detecting that the non-user principal is a service principal and is assigned to a dynamic group; and
in response to detecting that the non-user principal is a service principal and is assigned to the dynamic group, disabling the dynamic group.

20. The system of claim 18, wherein undertaking the one or more containment actions comprises:
detecting that (i) the non-user principal is an instance principal or a resource principal and (ii) is assigned to a dynamic group; and
in response to detecting that the non-user principal is an instance principal or a resource principal and is assigned to the dynamic group, removing the non-user principal from the dynamic group.
